(19) United States
(12) Patent Application Publication
(10) Pub. No.: US 2016/0278424 A1
(43) Pub. Date: Sep. 29, 2016

(54) SYSTEM AND METHOD FOR DISPENSING UV TREATED MATERIALS

(71) Applicant: Rayvio Corporation, Hayward, CA (US)

(72) Inventors: Yitao LIAO, Hayward, CA (US); Robert WALKER, Hayward, CA (US); Doug COLLINS, Hayward, CA (US)

(21) Appl. No.: 14/943,628

(22) Filed: Nov. 17, 2015

Related U.S. Application Data
(63) Continuation-in-part of application No. 14/672,077, filed on Mar. 27, 2015.
(60) Provisional application No. 62/187,169, filed on Jun. 30, 2015.

(51) Int. Cl. A23L 3/28; C02F 1/32

(52) U.S. Cl. CPC A23L 3/28; C02F 1/325; C02F 2303/04; C02F 2201/3222; C02F 2201/3228; C02F 2201/326; C02F 2201/3227

(57) ABSTRACT

A device for providing treated materials includes a storage portion comprising an enclosed region with sidewalls, an input portion and UV-LEDs, wherein the enclosed region stores material and includes a UV-responsive material, wherein the input portion receives the material, wherein the UV-LEDs provide UV-A illumination range within the enclosed region and the UV-responsive material inhibits contaminant formation upon the sidewalls in response to the UV-A illumination, and a material treatment portion having sidewalls, UV-LEDs and an output portion, wherein the sidewalls are configured to reflect UV light, wherein material treatment portion receives the material from the storage portion, wherein the UV-LEDs provide UV-B and/or UV-C illumination to treat or sanitize the material within the material treatment portion, and wherein the output portion is for providing output of the treated material.

### CROSS-REFERENCE TO RELATED APPLICATIONS

The present invention is a continuation-in-part of U.S. patent application Ser. No. 14/672,077, filed Mar. 27, 2015 and claims priority to U.S. Provisional Application No. 62/187,169, filed Jun. 30, 2015.

### BACKGROUND OF THE INVENTION

The present invention relates to sanitation of consumable materials. More specifically, embodiments of the present invention relate to methods and apparatus for facilitating sanitation of liquids such as water or juices and solids such as ice, or the like.

A problem recognized by the inventors is that although water stored in water bottles may be relatively safe to drink, the exterior portions of the water bottles may have many types of contaminants. These contaminants may originate from the water bottle factory, from road dirt during transport of the water bottle, from storage of the water bottle prior to use, and the like. The inventors have discovered that contaminants may be introduced into the water when the bottle is inverted and placed into a water dispenser, and when the water splashes out into a water receiving portion. Further, the inventors have discovered that typical water dispenser (or, water coolers) may be ideal locations for growth of molds, fungus, germs and other pathogens because of humid and dark conditions of water dispenser.

The inventors have considered the idea of using UV light derived from the most common source of UV-illumination, low-pressure or medium-pressure mercury vapor bulbs to destroy the pathogens within the interior surfaces of a water dispenser. Such a concept, however, has many drawbacks. Some drawbacks include that the limited life span (1000 to 5000 hours) for mercury vapor bulbs makes it unsuitable for water dispensers that are designed for years of service; and that turning on and off a mercury vapor bulb greatly reduces the bulb's life span. Additional drawbacks include that such bulbs do not operate efficiently in colder temperatures, such as a chilled-water storage containers. Further, if mercury bulbs break, poisonous mercury may leech into the water, without anyone being aware of it. For such reasons, the inventors do not believe it is practical to use vapor-based UV-lights to maintain sanitation of water dispensers.

The inventors have also considered the idea of using antimicrobial-laced materials (e.g. silver-based) within a water dispenser. Although such materials appear effective in reducing pathogen growth on the surfaces of such materials, it does not reduce pathogens in the water itself. Further, the inventors are concerned about the long-term effects of such materials leaching into the water supply and human consumption of such antimicrobial compounds.

The inventors of the present invention have come to believed that improved apparatus and methods for providing liquids safe for consumption is desirable.

### BRIEF SUMMARY OF THE INVENTION

Embodiments of the present invention include a water dispenser comprising an intake portion and a storage portion. Sidewalls of the intake portion and the storage portion may be coated with one or more photo-reactive materials that are reactive to UV illumination, and include one or more UV light emitting diodes (LEDs) that output light within the UV-A spectral range (UV-A, UV-B and UV-C are defined as: UV-A from 400 nm to 315 nm, UV-B from 315 nm to 280 nm, and UV-C from 280 nm to 100 nm). In various embodiments, the UV-LEDs output UV light, strike the reactive materials, and generate free-radicals from the water and vapor, within the region of the sidewalls. In turn, the free-radicals attack contaminants formed on and in the proximity from the sidewalls, such as mold, mildew, or the like, prevent such formation on the sidewalls, and the like. Accordingly, formation of contaminants within the intake portion and storage portion are reduced.

Additionally, in various embodiments, the water dispenser may include a sanitation portion that receives water from the storage portion. This portion may include an open-ended volumetric region formed of material that is UV reflective and one or more UV-LEDs that output light within the UV-B and/or UV-C (hereby and below referred to as the UV-B and/or C LEDs) range. In various embodiments, the UV-LEDs output UV light directly or indirectly to the water within the volumetric region to attack contaminants within the water. Accordingly, contaminants (including pathogens) with the water are reduced, and the water is made more safe for consumption.

In some embodiments, various timers and power adjustment parameters may be used to control the UV-A-LEDs and the UV-B and/or C-LEDs. In such embodiments, one or more sensors may be included to determine a contamination level of the water, for example, and the output parameters of the UV-LEDs may be adjusted, accordingly. For example, in some examples, a voltage magnitude may be changed, a duty cycle may be changed, an on time may be changed, and the like. As an example of this, for highly contaminated water, the power applied to UV-C-LEDs may be increased, and the duration of the UV-B and/or C illumination of the water within the sanitation portion may also be increased.

In other embodiments, a detected water contamination level, UV-LED illumination and power parameters, and the like may be stored within an on-board memory. Such data may be accessed or monitored by a user, for example, via a smartphone application. In other embodiments, such data may be automatically uploaded to a remote server. The remote server may receive data from a multitude of water customers and thus be able to track water quality over a wide-geographic area.

Various embodiments described herein are directed to water, however, it should be understood that embodiments herein are also directed to dispensing other types of liquids, including carbonated water, juices, milk, beer and the like; and dispensing of solid materials, such as ice. In other embodiments, instead of separate water bottle, a waterline may be coupled to the water dispenser/cooler for supplying water. Such embodiments may still include UV-LED illumination (e.g. UVA/B or C) within a water storage portion and UV-LED illumination (UVB and/or C) within a water output portion.

According to one aspect of the present invention, a device for providing treated material is disclosed. One device includes a material storage portion comprising an enclosed region having sidewalls, an input portion and at least one first UV-LED, wherein the enclosed region is for storing material, wherein a UV-responsive material is disposed upon the sidewalls, wherein the input portion is for receiving the material, wherein the first UV-LED is for providing UV-A illumination within the UV-A frequency range within the enclosed region, wherein the UV-responsive material inhibits contaminant formation upon the sidewalls in response to the UV-A illumination. One apparatus includes a material treatment portion coupled to the material storage portion, wherein the material treatment portion comprises a treatment region having sidewalls, an input portion, at least one second UV-LED and an output portion, wherein the sidewalls are configured to reflect UV light, wherein the input portion is for receiving the material from the material storage portion, wherein the second UV-LED is for providing UV-B and/or C illumination within the UV-B and/or C frequency range to material within the material treatment portion, wherein the material within the material treatment portion is treated in response to the UV-B and/or C illumination, and wherein the output portion is for providing output of the treated material.

Another aspect of the present invention includes methods for providing treated materials. One technique includes receiving material through an input portion of an enclosed container, storing the material within the enclosed container, and illuminating sidewalls of an enclosed container with UV-A illumination within the UV-A frequency range with a first UV-LED, wherein the sidewalls of the enclosed container comprise a UV-responsive material, wherein the sidewalls generate a plurality of free-radicals within material proximate to the sidewalls, and wherein the free-radicals inhibit contaminant formation upon the sidewalls. A process includes receiving a portion of the material from the enclosed container in a treatment region of a material treatment portion, wherein the treatment region comprises sidewalls, illuminating the portion of the material with UV-B and/or C illumination within the UV-B and/or C frequency range with the second UV-LED, wherein the sidewalls of the treatment region reflect UV-C illumination, wherein the portion of the material within the treatment region is treated in response to the UV-B and/or C illumination and forms treated material, and providing output of the treated material to one or more users.

Various additional objects, features and advantages of the present invention can be more fully appreciated with reference to the detailed description and accompanying drawings that follow

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1 illustrates a diagram of an embodiment of the present invention;

FIGS. 2A-C illustrate a block diagram of a method of operation according to various embodiments of the present invention; and

FIG. 3 illustrates a block diagram of portions of various embodiments of the present invention.

### DETAILED DESCRIPTION OF THE INVENTION

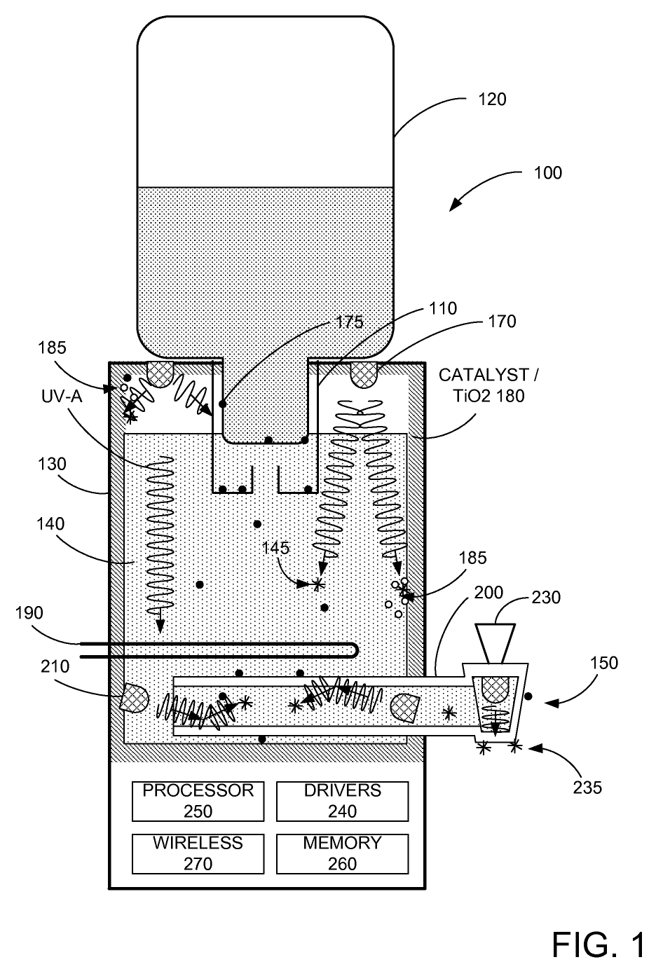

FIG. 1 illustrates a diagram of an embodiment of the present invention. More specifically, FIG. 1 is a diagram of a typical water cooler 100 found in many homes and businesses in the US and other countries. As shown, water cooler 100 includes a receiving portion 110 adapted to receive a water source (e.g. water bottle) 120, a central storage tank 130 for storage of water 140, and an output portion 150. In various embodiments, water source 120 and/or central storage tank 130 may be of any size, for example 1 cup to 10's of gallons or even larger. In some embodiments, water source 120, central storage tank 130, and output portion 150 may be located at the same physical device, or remote from each other. For example, in some embodiments, water source 120 may be a water tank in a dwelling, a municipal water supply, or the like, and a water line is connected to the central storage tank 130. Additionally, central storage tank 130 can supply liquids to one or more output portions 150.

In various embodiments, central storage tank 130 and/or receiving portion 110 includes one or more UV-LEDs 170 disposed therein. In some configurations, UV-LEDs 170 may be embedded (e.g. flush with or protruding into) the sidewalls of storage tank 130, may be disposed behind one or more UV transparent regions (e.g. glass, Teflon, etc.) of the sidewalls, or the like. In some embodiments, UV-LEDs 170 are configured to output UV light primarily in the UV-A frequency range, although in other embodiments the UV-LEDs may also be configured to output UV light primarily in the UV-B and/or C frequency range, or the like.

In various embodiments, the sidewalls of central storage tank 130 and/or receiving portion 110 may include a material coating 180. Material coating 180 comprises one or more materials that are reactive to the UV light from UV-LEDs 170. In some embodiments, material coating 180 includes TiO2, a UV reactive material, or the like. Central storage tank 130 may also include one or more heating or cooling elements 190. In some embodiments elements 190 may also include a material coating that may be reactive to UV light, may be UV reflective, or the like.

In some embodiments, when UV light directly or indirectly strikes material coating 180 it generates free-radicals 185 in the water (liquid or vapor) adjacent thereto. For example, when UV-A light strikes a TiO2 material coating, it generates H+ and OH− ions from water. In turn, the free-radicals attack contaminants that are disposed on material coating 180, such as mold, mildew, bacteria or the like. Accordingly, in various embodiments, growth of contaminants on the sidewalls is greatly reduced or inhibited. Additionally, when water 140 is circulated within central storage tank 130, water 140 may be treated or sanitized to some degree 145. In some embodiments, storage tanks 130 may include one or more protrusions, or the like that increases the surface area of the reactive material in contact with water 140. Such embodiments may increase the amount of treatment of water 140.

In various embodiments, the water dispenser may include an output/sanitation portion 150 that receives water from the storage portion 140. As illustrated in FIG. 1, output portion 150 includes a housing 200 (e.g. open-ended) that roughly defines a volumetric region where water 140 is subject to further treatment. In various embodiments, output portion 150 includes one or more UV-LEDs 210. In some configurations, UV-LEDs 210 may be embedded (e.g. flush with or protruding into) the sidewalls of housing 200, may be disposed behind one or more UV transparent regions (e.g. glass, Teflon, etc.) of the sidewalls, or the like. In some embodiments, UV-LEDs 210 are configured to output UV light primarily in the UV-B and/or C frequency range, although in other embodiments the UV-LEDs may also be configured to output UV light primarily in the UV-A frequency range, or the like.

In various embodiments, housing 200 may be made of a material or may or include a coating of one or more materials that are reflect the UV light from UV-LEDs 210. In some embodiments, material or material coating includes stainless steel, aluminum, Teflon, UV reflective material, or the like.

In some embodiments, UV light from UV-LEDs 210 is directed towards water 140 within housing 200. When the UV light strikes housing 200, it reflects the UV light back towards water 140. In various embodiments, as the UV-B and/or C light from UV-LEDs 210 strikes water 140 it sanitizes or treats water 140 and reduces any pathogens, e.g. germs, viruses, bacteria, prions, therein, as illustrated.

Additionally, UV light from UV-LEDs 210 may be directed towards one or more water spouts 230. In such embodiments, UV-B and/or C light may be used to reduce surface contaminants on water spouts 230. For example, if a child places their mouth directly upon water spout 230 and leaves contaminants 235, the UV-C light will sanitize the spout for subsequent users. In such embodiments, blue-color LEDs or the like may also be included to visually indicate to users when UV-LEDs 210 are active.

In some embodiments, UV-LEDs 170 and 210 may be continually active, or periodically active, depending upon sanitation requirements, quality of water, ambient temperature, ambient humidity, or the like. As merely examples, UV-LEDs 170 may be powered and may provide UV-A light at 100% intensity within storage tank 130 for five minutes every hour; may provide UV-A light at 50% intensity for one minute every ten minutes; may provide UV-A light at 100% intensity, but with a 50% duty cycle for five minutes every hour; or the like. As mentioned above, the amount of UV light may depend upon a number of factors such as temperature, water quality, and the like. As merely examples, UV-LEDs 210 may be powered and may periodically provide UV-B and/or C light at 50% intensity when water 140 has a first threshold of clarity and may periodically provide UV-B and/or C light at 80% intensity when water 140 has a second water quality; may periodically provide UV-B and/or C light one minute every five minutes when water 140 or an ambient temperature is at a first temperature and may provide UV-B and/or C light one minute every ten minutes when water 140 or an ambient is at a second temperature. In various embodiments, the UV-LEDs may be driven under a different set of conditions when a high water flow rate is detected. For example, UV-LEDs 210 may be powered and may provide UV-B and/or C light continuously at 100% when a maximum water flow rate is detected, and for one minute thereafter. Subsequent to the one minute, the UV-LEDs 210 may be driven by their default pattern, or the like. In light of the present disclosure, other combinations of intensity, duty cycle, and periodicity should be envisioned in alternative embodiments by one of ordinary skill in the art.

In various embodiments, UV-LEDs 170 and 210 may be driven by LED drivers 240 and controlled by processor 250. Various patterns or schedules for driving UV-LEDs 170 and 210 may be stored in memory 260, or the like. Also included in various embodiments of water cooler 100 is a communication module 270 that allows for transfer of data (e.g. water quality data, usage data, and the like) to a user and/or a remote server. Further details regarding possible supporting hardware will be given below.

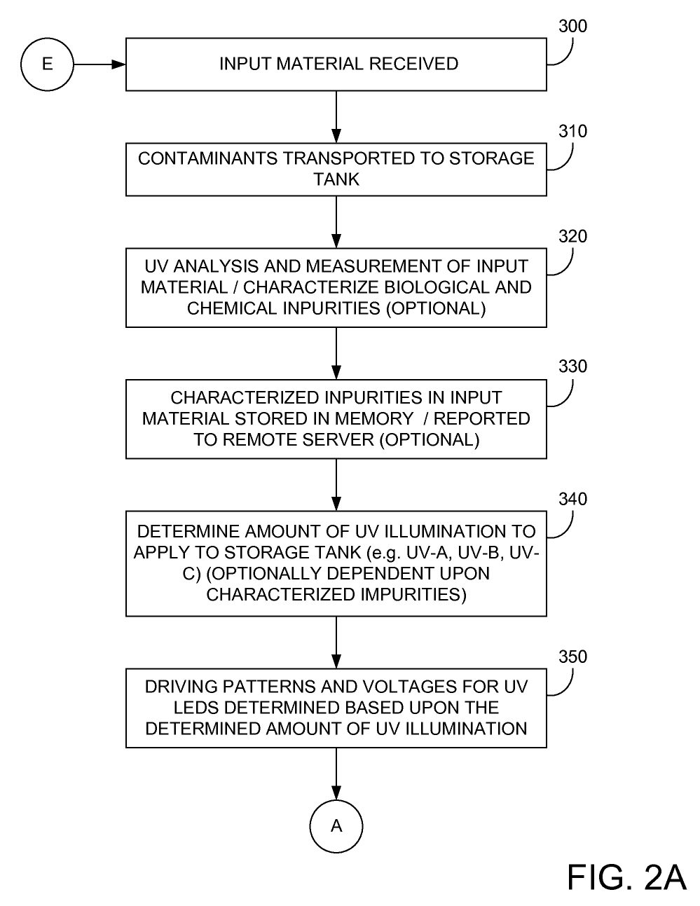

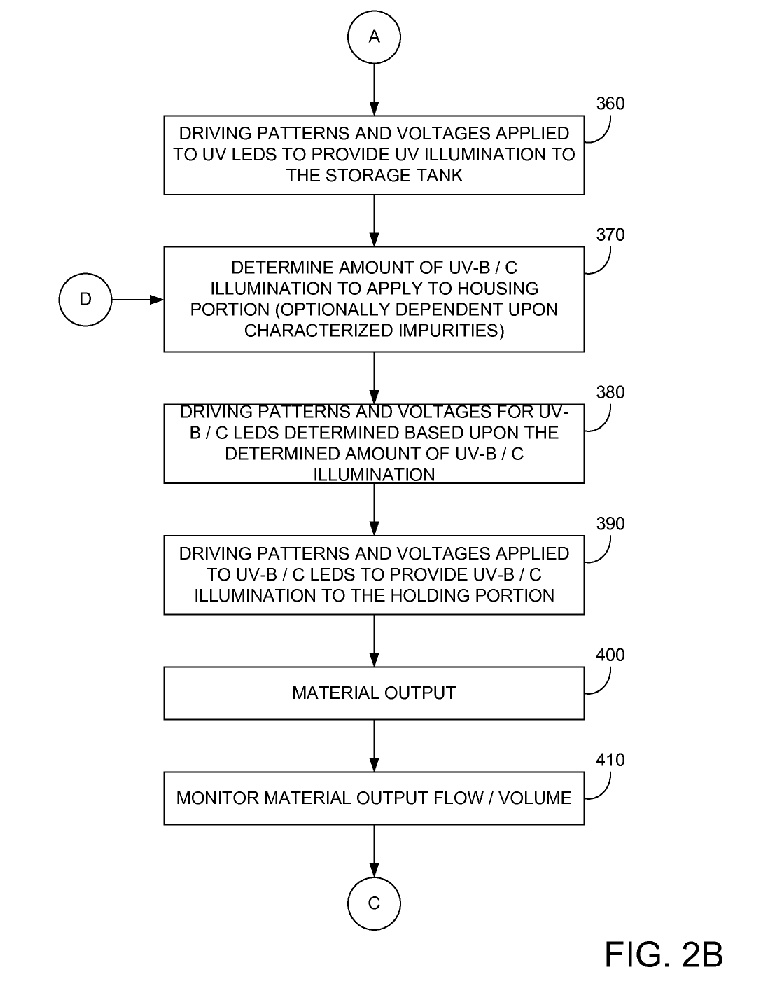

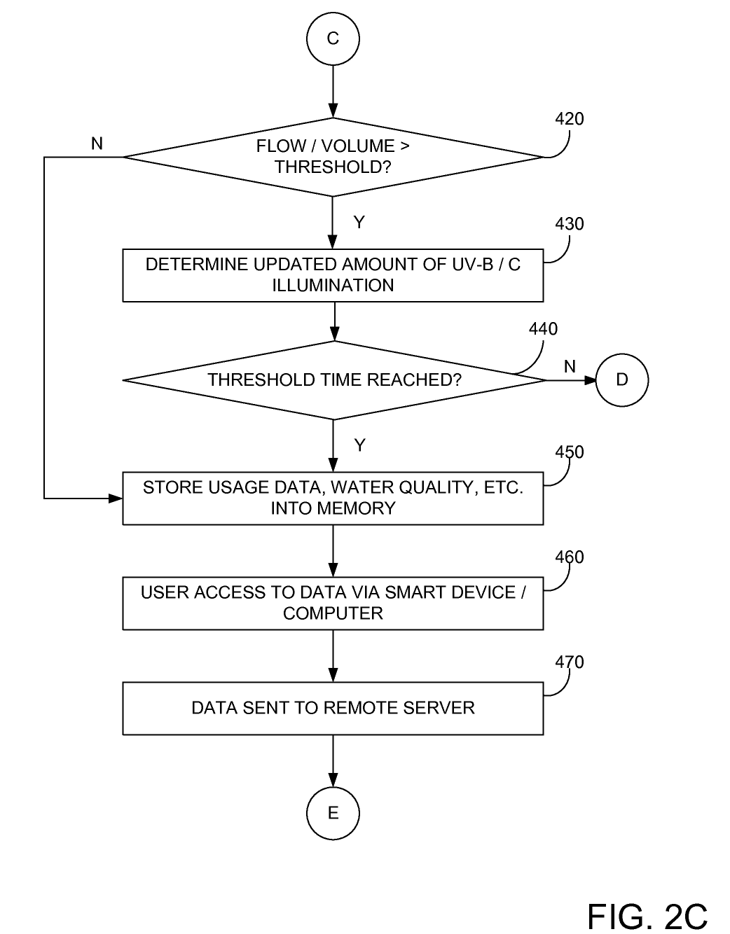

FIGS. 2A-C illustrate a block diagram of a method of operation according to various embodiments of the present invention, with reference to FIG. 1. Initially, a user places water bottle 120 onto receiving portion 110 of water cooler 100, step 300. As illustrated, water 140 and contaminants 175 (within in water 140 and/or on the exterior surface) are received by water cooler 100 and then transported to storage tank 130, step 310. In various embodiments, a number of parameters may be measured of water 140 and/or the ambient conditions, such as humidity, temperature, water clarity, pH, and the like, step 320. These parameters may be stored in an on-board memory 260 and/or uploaded to a remote server, step 330. In various embodiments, on-board memory may be accessed locally via a user via a smart phone application, or the like, via Wi-Fi, NFC, Bluetooth, or the like. Additionally, the parameters may be accessed by or provided to a remote sever via the user's smart phone application, via a wired or wireless communication mechanism (e.g. Wi-Fi, 4G, or the like).

Based upon one or more parameters, processor 350 determines the amount of UV light to output to storage tank 130 via UV-LEDs 170, step 340. In various embodiments, one or more combinations of intensity, duty cycle, periodicity, and the like are determined, as discussed above. Power is then selectively provided to UV-LEDs 170, step 350. The UV-A light is then provided to storage tank 130 and/or receiving portion 110, to reduce the amount of surface contaminants, step 360.

Additionally, upon one or more parameters, processor 250 determines the amount of UV light to output to output portion 150 via UV-LEDs 210, step 370. In various embodiments, one or more combinations of intensity, duty cycle, periodicity, water flow rate, and the like are determined, as discussed above. Power is then selectively provided to UV-LEDs 210, step 380. The UV-B and/or C light is then provided to water 140 within housing 200 and/or output spout 230, to reduce the amount of pathogens in water 140, step 390. When the user operates output spout 230 water with reduced amounts of pathogens is output, step 400.

In various embodiments, a water flow rate is measured, step 410. When the water flow rate exceeds a threshold, step 420, processor 250 determines an updated amount of UV light to output to output portion 150 via UV-LEDs 210, step 430. These steps are directed to a situation with high flow rate or high volume draw. In such cases, it is possible that some water 140 within housing 200 may not have been exposed to sufficient UV-B and/or C light prior to being output, accordingly, in these steps, the amount of UV-B and/or C light may be maximized or increased to quickly reduce the contaminants within the water within housing 200. The high power output for UV-LEDs 210 continues until a certain amount of time has elapsed, step 440. The process can then return to step 380.

In some embodiments, the various water quality parameters, ambient parameters, water draw, or the like are stored in memory 260, step 450. A user may access such data via smart phone, computer, or the like, step 460. Additionally, such data may be sent to a remote server, step 470. In various embodiments, the data may be automatically sent to the remote server and/or the remote server may request such data from the water dispenser.

In alternative embodiments, other types of parameters may be stored within a memory and provided to the user and/or a remote user. For example, in some embodiments, a water dispenser may include an active filter cartridge to help reduce chemical contaminants, particles, or the like. In some embodiments the amount of water drawn from water dispenser may be measured and when a threshold amount is reached, water dispenser may alert the user or the remote server that the filter should be changed.

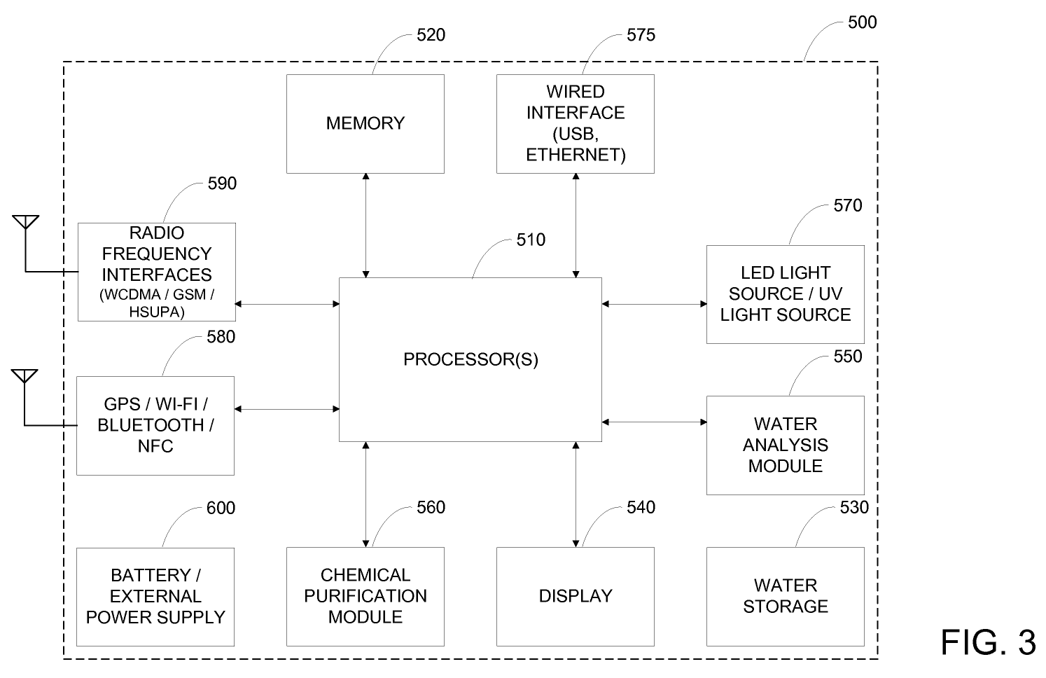

FIG. 3 illustrates a functional block diagram of various embodiments of the present invention. In particular, FIG. 3 illustrates more detailed electronic computation, communications, and driving portions of a water (or other media) dispenser. In FIG. 3, a device 500 may include one or more processors 510. Such processors 510 may also be termed application processors, and may include a processor core, a video/graphics core, and other cores. Processors 510 may be a processor from Apple (S1), Intel (Quark SE), NVidia (Tegra K1, X1), Marvell (Armada), Qualcomm (Snapdragon), Samsung, TI (OMAP), or the like. In various embodiments, the processor core may be an Intel processor, an ARM Holdings processor such as the Cortex-A, -M, -R or ARM series processors, or the like. Other processing capability may include audio processors, interface controllers, and the like. It is contemplated that other existing and/or later-developed processors may be used in various embodiments of the present invention, including processors having greater processing capability (e.g. Intel Core)

In various embodiments, memory 520 may include different types of memory (including memory controllers), such as flash memory (e.g. NOR, NAND), pseudo SRAM, DDR SDRAM, or the like. Memory 520 may be fixed within device 500 or removable (e.g. SD, SDHC, MMC, MINI SD, MICRO SD, CF, and SIM). The above are examples of computer readable tangible media that may be used to store embodiments of the present invention, such as computer-executable software code (e.g. firmware, application programs), application data, operating system data or the like. It is contemplated that other existing and/or later-developed memory and memory technology may be used in various embodiments of the present invention.

In various embodiments, display 530 may be provided based upon a variety of current or later display technology including displays having touch-response, (e.g. resistive displays, capacitive displays, optical sensor displays, electromagnetic resonance, or the like). Any later-developed or conventional output display technology may be used for the output display, such as TFT-LCD, OLED, Plasma, trans-reflective (Pixel Qi), electronic ink (e.g. electrophoretic, electrowetting, interferometric modulating). In various embodiments, the resolution of such displays and the resolution of such touch sensors may be set based upon engineering or non-engineering factors (e.g. sales, marketing). In some embodiments of the present invention, a display output port, such as an HDMI-based port or DVI-based port may also be included. In various embodiments, display 530 may include status lights and informational displays regarding the status of device 500.

In some embodiments of the present invention, water analysis module 550 may be provided and include multiple UV-LED light sources, each having unique UV light output frequencies, and one or more optical sensors. In various embodiment, UV-LED light sources have a relative narrow output peak (e.g. on the order of 10 nm to 20 nm, or 20 nm to 30 nm), and are embodied as UV-LEDs currently being developed by the current assignee of the present application. The narrow output peaks allows embodiments of the present invention to differentiate between different types of contaminants and impurities. For example 210 nm to 250 nm range can detect Nitrites (NO2) and Nitrates (NO3), 250 nm to 380 nm can detect Total Organic Carbon (TOC), Dissolved Organic Carbon (DOC), Chemical Oxygen Demand (COD),

Biochemical Oxygen Demand (BOD), Color (Hazen), Assimilable Organic Carbon (AOC, 240 nm and 300 nm range can detect Ozone, 360 to 395 nm can detect Benzene, Toluene and Xylene (BTX) and Turbidity (NTU) and the like. In some embodiments, a single water analysis module 550 may only analyze purified water, or may analyze incoming and purified water. In other embodiments, two water analysis modules 550 are provided, one for incoming water, and one for purified (treated) water.

In various embodiments, mechanical/chemical purification module 560 may be provided and include one or more porous membranes to filter-out contaminants particles suspended in the water. Additionally, module 560 may include any number of chemicals to reduce chemical contaminants in the water. In some examples, module 560 may include an activated charcoal filter to reduce chlorine and TOC (total organic carbon), DOC (dissolved organic carbon), COD (chemical oxygen demand), TOC, DOC and COD and the like. In various embodiments, incoming water is treated with module 560 prior to treatment with UV module 570.

In various embodiments, UV module 570 includes UV-A LEDs 170 and UV-B and/or C LEDs 210 to expose water 140 and walls of water storage 530 to different ranges of UV light to destroy different types of pathogens. In some examples, multiple frequencies of light are used to treat water 140. For example, UV light in the 214 nm range is used to destroy MS2 coliphage, UV light in the 265 nm range is used to destroy B. subtilis and the like. In some embodiments, UV module 570 may also include embodiments of UV-LEDs under development by the current assignee. Such embodiments may directly target the pathogens determined in water analysis module 550 on the incoming water. For example, if only B. subtilis is detected in module 550, only UV-LEDs having an output range of about 260 nm to about 270 nm can be activated, to attack the B. subtilis. In other embodiments, a broad-band UV light source, e.g. medium pressure UV bulb may also be used, to purify the water, regardless of whether any pathogens are detected.

In some embodiments, a photo detector, such as a photodiode, or a PMT (photomultiplier), or a spectrometer, can be used in the system to monitor optical signal generated by the UV-LED when transmitted through the water.

In some embodiments, GPS receiving capability may also be included in various embodiments of the present invention, however is not required. The GPS functionality may provide the remote server with the geographic location of device 500.

FIG. 3 is representative of one device 500 capable of embodying the present invention. It will be readily apparent to one of ordinary skill in the art that many other hardware and software configurations are suitable for use with the present invention. Embodiments of the present invention may include at least some but need not include all of the functional blocks illustrated in FIG. 3. Further, it should be understood that multiple functional blocks may be embodied into a single physical package or device, and various functional blocks may be divided and be performed among separate physical packages or devices.

Further embodiments can be envisioned to one of ordinary skill in the art after reading this disclosure. For example, device 500 may be powered by any number of sources 600 including: AC from a wall outlet, solar-derived power, battery, manual crank or the like.

In other embodiments, combinations or sub-combinations of the above disclosed invention can be advantageously made. For example, in FIG. 1, one or more UV wave guides may extend from the bottom surface. Such embodiments could increase the diffusion of UV light. In another embodiment, the filter in the filtration process may include TiO2 material inside, where upon water will flow through the filter and be exposed to the surface of the TiO2 material (TiO2 nano particle, thin film, micro sphere, powder, etc.) UV light may be optionally delivered to the TiO2 material located inside the filter via light guiding technology, such as optical fiber or optical light guide blades. Such embodiments will increase the surface area of the TiO2 material exposed to the liquid, thus the oxidation capability will increase. In some embodiments, the UV illumination in the central water tank may be UV-A, UV-B, and/or UV-C light. In various embodiments, an existing water cooler, or the like may be retrofitted with the above-described capability. For example, in some embodiments, a UV-reactive material may be added into a central water tank in an existing water dispenser may and UV sources may be provided to illuminate the UV-reactive liner material. In some embodiments, the UV-reactive material may be disposed upon a substrate, e.g. plastic. In other embodiments, a UV-B and/or C water output treatment portion (e.g. 150) may be installed on an existing water cooler. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A device for providing treated materials comprising:
a material storage portion comprising an enclosed region having sidewalls, an input portion and at least one first UV-LED, wherein the enclosed region is for storing material, wherein a UV-responsive material is disposed upon the sidewalls, wherein the input portion is for receiving the material, wherein the first UV-LED is for providing UV illumination, wherein the UV-responsive material inhibits contaminant formation upon the sidewalls in response to the UV illumination; and
a material treatment portion coupled to the material storage portion, wherein the material treatment portion comprises a treatment region having sidewalls, an input portion, at least one second UV-LED and an output portion, wherein the sidewalls are configured to reflect UV light, wherein the input portion is for receiving the material from the material storage portion, wherein the second UV-LED is for providing UV-B and/or UV-C illumination within the UV-B and/or UV-C frequency range to material within the material treatment portion, wherein the material within the material treatment portion is treated in response to the UV-B and/or UV-C illumination, and wherein the output portion is for providing output of the treated material.

2. The device of claim 1 wherein the UV-responsive material is selected from a group consisting of: TiO2, UV-reactive coating.

3. The device of claim 1 wherein the contaminant is selected from a group consisting of: mold, mildew, algae, germs, biofilm, and pathogens.

4. The device of claim 1 wherein the material treatment portion is selected from a group consisting of: stainless steel, aluminum, Teflon, and UV-reflective surface.

5. The device of claim 1 wherein the material treatment portion is disposed at least partially within the material storage portion.

6. The device of claim 1 further comprising:
a processing unit configured to determine first driving parameters for the first UV-LED and second driving parameters for the second UV-LED; and
a driver portion coupled to the processing unit, the first UV-LED and the second UV-LED, wherein the driver portion is configured to selectively provide first power signals to the first UV-LED in response to the first driving parameters and the second power signals to the second UV-LED in response to the second driving parameters.

7. The device of claim 6 wherein the second driving parameters are selected from a group consisting of: duty cycle, DC voltage, amplitude, and duration

8. The device of claim 1 further comprising:
a detection portion coupled to the material storage portion, wherein the detection portion is configured to detect impurities within the material in response to the UV illumination;
a reporting portion coupled to the detection portion, wherein the detection portion is configured to report the impurities detected by the detection portion to a remote server; and
wherein the reporting portion comprises a communication mechanism selected from a group consisting of: Wi-Fi, Bluetooth, ZigBee, NFC, satellite, and cellular.

9. The device of claim 1 wherein the treated material is selected from a group consisting of: water, ice, juice, beer, wine, and milk.

10. The device of claim 1 further comprising a treated material output portion coupled to the output portion of the material treatment portion, wherein the treated material output portion comprises a controllable valve and a third UV-LED, wherein the controllable valve is configured to allow a user to control output of the treated material, and wherein the third UV-LED is for providing UV-B and/or UV-C illumination within the UV-B and/or UV-C frequency range to the controllable valve, wherein surfaces of the controllable valve are sanitized in response to the UV-B and/or UV-C illumination.

11. A method for providing treated materials comprising:
receiving material through an input portion of an enclosed container;
storing the material within the enclosed container;
illuminating sidewalls of an enclosed container with UV-A illumination within the UV-A frequency range with a first UV-LED, wherein the sidewalls of the enclosed container comprise a UV-responsive material, wherein the sidewalls generate a plurality of free-radicals within material proximate to the sidewalls, and wherein the free-radicals inhibit contaminant formation upon the sidewalls;
receiving a portion of the material from the enclosed container in a treatment region of a material treatment portion, wherein the treatment region comprises sidewalls;
illuminating the portion of the material with UV-B and/or UV-C illumination within the UV-B and/or UV-C frequency range with the second UV-LED, wherein the sidewalls of the treatment region reflect UV-B and/or UV-C illumination, wherein the portion of the material within the treatment region is treated in response to the UV-B and/or UV-C illumination and forms treated material; and
providing output of the treated material.

12. The method of claim 2 wherein the UV-responsive material is selected from a group consisting of: TiO2 and UV-reactive material.

13. The method of claim 11 wherein the contaminant is selected from a group consisting of: mold, mildew, algae, germs, and pathogens.

14. The method of claim 11 wherein the material treatment portion is selected from a group consisting of: stainless steel, aluminum, Teflon, and UV-reflective material.

15. The method of claim 11 wherein the material treatment portion is disposed at least partially within the material storage portion.

16. The method of claim 11 further comprising:
a processing unit configured to determine first driving parameters for the first UV-LED and second driving parameters for the second UV-LED; and
a driver portion coupled to the processing unit, the first UV-LED and the second UV-LED, wherein the driver portion is configured to selectively provide first power signals to the first UV-LED in response to the first driving parameters and the second power signals to the second UV-LED in response to the second driving parameters.

17. The method of claim 16 wherein the second driving parameters are selected from a group consisting of: duty cycle, DC voltage, amplitude, and duration.

18. The method of claim 11 further comprising:
detecting in a detection portion, impurities within the material within the enclosed container in response to the UV illumination; and
a reporting portion coupled to the detection portion, wherein the detection portion is configured to report the impurities detected by the detection portion to a remote server.

19. The method of claim 18 wherein the reporting portion comprises a communication mechanism selected from a group consisting of: Wi-Fi, Bluetooth, ZigBee, NFC, satellite, and cellular.

20. The device of claim 1 further comprising a treated material output portion coupled to the output portion of the material treatment portion, wherein the treated material output portion comprises a controllable valve and a third UV-LED, wherein the controllable valve is configured to allow a user to control output of the treated material, and wherein the third UV-LED is for providing UV-C illumination within the UV-C frequency range to the controllable valve, wherein surfaces of the controllable valve are sanitized in response to the UV-C illumination.
